(19) United States
(12) Patent Application Publication
(10) Pub. No.: US 2023/0096336 A1
(43) Pub. Date: Mar. 30, 2023

(54) OPTICAL SYSTEM OF AUGMENTED REALITY HEAD-UP DISPLAY

(71) Applicant: WayRay AG, Zurich (CH)

(72) Inventors: Andrey Mikhailovich Belkin, Zurich (CH); Oleg Igorevich Bushmanov, Moscow (RU); Vitaly Andreevich Ponomarev, Zurich (CH); Anton Alekseevich Shcherbina, Zurich (CH); Mikhail Aleksandrovich Svarycheuski, Zurich (CH)

(73) Assignee: WayRay AG, Zurich (CH)

(21) Appl. No.: 17/488,745

(22) Filed: Sep. 29, 2021

(51) Int. Cl. G02B 27/01

(52) U.S. Cl. CPC G02B 27/0101; G02B 2027/013

(57) ABSTRACT

An optical system includes a picture generation unit configured to output an optical image, a correcting optical element, and a combiner. The shape of the combiner and the shape of the correcting optical element are correlated such that the optical system can produce augmented reality at relatively long distances (e.g., 1.5 meters or more). The correcting optical element includes a convex reflective surface configured to reflect the optical image output by the picture generation unit. The combiner has a concave reflective surface and a convex transparent surface. The concave reflective surface of the combiner is configured to reflect the optical image reflected by the correcting optical element toward an eye box, which represents an eye pupil of the observer. The convex transparent surface of the combiner is configured to permit external light to pass through the combiner and combine with the optical image reflected by the correcting optical element.

### BACKGROUND

Transparent optical systems, such as head-up displays, provide the ability to present information and graphics to an observer without requiring the observer to look away from a given viewpoint or otherwise refocus his or her eyes. In such systems, the observer views an external scene through a combiner. The combiner allows light from the external scene to pass through while also redirecting an image artificially generated by a projector so that the observer can see both the external light as well as the projected image at the same time.

### BRIEF DESCRIPTION OF THE DRAWINGS

FIG. 1 is a block diagram of an augmented reality display environment, in accordance with an embodiment of the present disclosure.

FIG. 2 is a schematic diagram of an optical system, in accordance with an embodiment of the present disclosure.

FIG. 3 is a schematic diagram of an optical system, in accordance with another embodiment of the present disclosure.

FIG. 4 is a schematic diagram of an optical system, in accordance with yet another embodiment of the present disclosure.

FIG. 5 is a graph showing the volume (size) of the optical system of FIGS. 2, 3, and/or 4 as a function of a focal length of the combiner for different distances to the virtual image, in accordance with some embodiments of the present disclosure.

FIG. 6 is a schematic diagram showing how a ray of light travels through an optical element, in accordance with some embodiments.

FIGS. 7A-B show a table listing various parameters of an optical system, in accordance with some embodiments.

FIG. 8 is a flow diagram of a method of combining external light with an optical image, in accordance with some embodiments.

### DETAILED DESCRIPTION

An optical system is disclosed herein. In an example, the optical system of an augmented reality head-up display includes a picture generation unit configured to output an optical image, a correcting optical element, and a combiner. The shape of the combiner and the shape of the correcting optical element are correlated such that the optical system can produce realistic long-distance augmented reality features within a given scene viewable through the combiner. The long-distance augmented reality features may appear to be, for instance, 1.5 meters or more from the observer. The correcting optical element includes a convex reflective surface configured to reflect the optical image output by the picture generation unit. The combiner has a concave reflective surface and a convex transparent surface. The concave reflective surface of the combiner is configured to reflect the optical image reflected by the correcting optical element toward an eye box, which represents an eye pupil of the observer. The convex transparent surface of the combiner is configured to permit external light to pass through the combiner and combine with the optical image reflected by the correcting optical element. So, for instance, in an example use case, the external light is from a real-world scene viewable through the windshield of a vehicle, and the optical image includes one or more virtual features that appear to be within the real-world scene at a distance that appears to be 1.5 meters or more away from the driver of the vehicle. Numerous other example use cases will be appreciated in light of this disclosure.

General Overview

As noted above, certain types of optical systems include a combiner that combines light from the external environment with artificially generated images to provide a head-up display. However, mismatches between the projected image and the combiner can lead to distortions or other undesirable visual effects. For example, when an optical system is used to generate augmented reality, the observer should perceive the virtual image generated by the system at the same distance from the observer as real-world objects in the external scene. Such distances can be, for example, 1.5 meters or longer. However, augmented reality is ineffective at distances greater than or equal to 1.5 meters if the combiner has insufficient optical power to create the virtual image at such distances or if the combiner otherwise introduces visual distortions into the virtual image or the external scene at such distances. This shortcoming is particularly acute in some applications, such as automotive and aeronautical applications, where the amount of available space for the optical system is very limited and does not provide enough clearance between the projector and the combiner to create realistic or otherwise undistorted virtual images at distances of 1.5 meters or more, which ultimately constrains the ability of the optical system to generate augmented reality.

To this end, in accordance with an example, an optical system is provided that is compact and can produce undistorted augmented reality in a head-up display at relatively long distances of (e.g., 1.5 meters or greater, and up to perceptible infinity). An example optical system includes a picture generation unit configured to output an optical image, a correcting optical element, and a combiner. The shape of the combiner and the shape of the correcting optical element are correlated such that the optical system can produce augmented reality at such relatively long distances. In more detail, the correcting optical element includes a convex reflective surface configured to reflect the optical image output by the picture generation unit. The convex reflective surface of the correcting optical element includes (i) a second- or higher-order reflective aspherical surface, (ii) a second- or higher-order decentered aspherical surface, or (iii) a freeform surface. In some examples, the convex reflecting surface of the correcting optical element has a shape such that a deviation of an angle between the chief rays of light exiting the combiner for either or both of the left and right eyes of the observer from a nominal value does not exceed 2 milliradians. In this manner, virtual image distortions caused by optical power of the combiner's reflective concave surface are reduced or eliminated.

Further, the combiner has a concave reflective surface and a convex transparent surface. The concave reflective surface of the combiner is configured to reflect the optical image reflected by the correcting optical element toward an eye box, which represents an eye pupil of the observer. The concave reflective surface includes (i) a second- or higher-order aspherical surface, (ii) a second- or higher-order decentered aspherical surface, or (iii) a freeform surface. The convex transparent surface of the combiner is configured to permit external light to pass through the combiner and combine with the optical image reflected by the correcting optical element. The convex transparent surface includes (i) a second- or higher-order aspherical surface, (ii) a second- or higher-order decentered aspherical surface, or (iii) a freeform surface. In some examples, an angle between imaginary and real directions of a view through the combiner at any eye position inside pupil area does not exceed 1 milliradian, which reduces or eliminates further optical distortions caused by the curvature of the concave reflective surface of the combiner. As will be appreciated in light of this disclosure, a reflective surface as used herein refers to a surface that is at least optically reflective, such that the surface at least reflects visible light; likewise, a transparent surface as used herein refers to a surface that is at least optically transparent, such that the surface at least passes visible light. Various other examples will be apparent in light of the present disclosure.

Example System

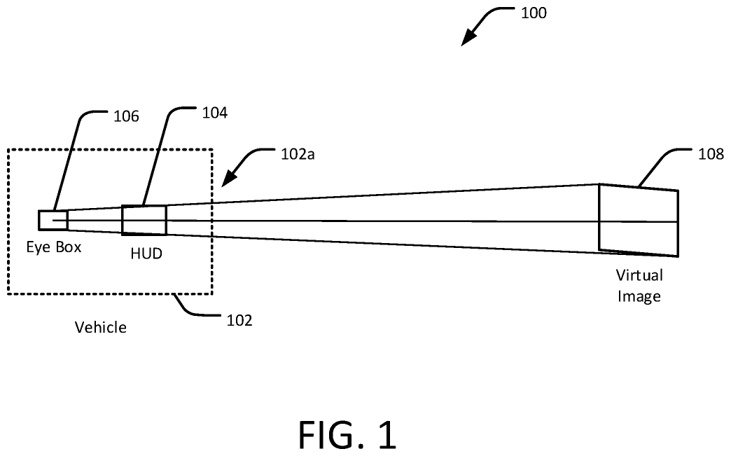

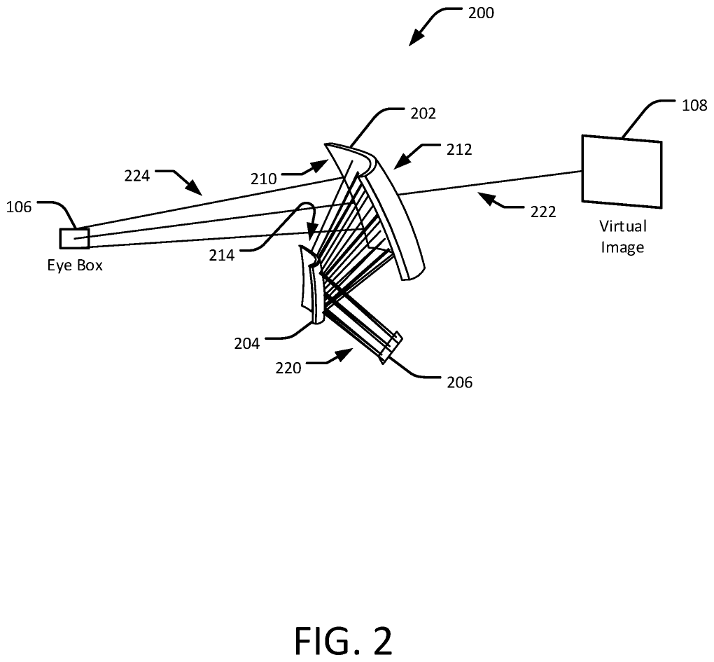

FIG. 1 is a block diagram of an augmented reality display environment 100, in accordance with an example of the present disclosure. The environment 100 includes a vehicle 102 with an optical system (such as a head-up display or HUD) 104. In some examples, the optical system 104 is mounted in the vehicle 102 between a windshield 102a and a driver, although it will be appreciated that the optical system 104 can be mounted in other environments, such as in the cockpit of an aircraft. The optical system 104 is configured to generate a virtual image 108 that is visible within an eye box 106 of the driver. The eye box 106 is a volume of space or location within which the virtual image 108 can be seen by either or both eyes of the driver, and thus the driver's head occupies or is adjacent to at least a portion of the eye box 106 during operation of the vehicle 102. The virtual image 108 includes one or more objects, symbols, characters, or other visible elements that are optically located ahead of the vehicle 102 such that the virtual image 108 appears to be at a non-zero distance (up to perceptible infinity) away from the optical system 104 (e.g., ahead of the vehicle 102). Such a virtual image 108 is also referred to as augmented reality when combined with light from a real-world environment, such as the area ahead of the vehicle 102. According to embodiments of the present disclosure, the optical system 104 is designed to occupy a relatively small and compact area (by volume) so as to be easily integrated into the structure of the vehicle 102. Several examples of the optical system 104 are described below with respect to FIGS. 2, 3, and 4.

FIG. 2 is a schematic diagram of an optical system 200, in accordance with an example of the present disclosure. The optical system 200 can be implemented as at least a portion of the optical system 104 of FIG. 1. The optical system 200 includes a combiner 202, a correcting optical element 204, and a picture generation unit (PGU) 206. The PGU 206 can include, in some examples, a thin-film-transistor liquid-crystal display (TFT LCD), an organic light emitting diode (OLED), an Active Matrix Organic Light Emitting Diode (AMOLED), a digital micromirror device (DMD) projector, a liquid crystal on silicon (LCOS) with a light emitting diode (LED), a laser projector, or other suitable illumination device. The PGU 206 is configured to generate and output an optical image 220, represented in FIG. 2 by a set of rays of light. Optical image 220 may include, for instance, one or more virtual features (such as symbols, characters, or other elements) to be projected into, or to otherwise augment, the real-world scene viewable through the combiner 202. The optical system 200 is arranged such that the optical image 220 output by the PGU 206 reflects first off of the correcting optical element 204 and next off of the combiner 202, then toward the eye box 106 of the driver or observer. The combiner 202 is further configured to permit at least some external light 222 (e.g., from a real-world environment) to pass through the combiner 202 and combine with the reflected optical image to produce an output image 224 (represented by a set of rays) visible at the eye box 106. In some examples, the output image 224 includes an augmented reality display of the virtual image 108, where at least some objects in the virtual image 108 generated by the PGU 206 are perceived by the driver or observer to be located at the same distance as real objects in the real-world environment.

The combiner 202 includes a concave reflective surface 210 and a convex transparent, or light transmitting, surface 212. The concave reflective surface 210 includes (i) a second- or higher-order aspherical surface, (ii) a second- or higher-order decentered aspherical surface, or (iii) a freeform surface. The freeform surface of the concave reflective surface 210 can be a non-regular, three-dimensional geometric surface defined by a set of points or a set of parametric equations. The concave reflective surface 210 reflects the optical image 220 output from the PGU 206 toward the eye box 106, creating a least a portion of the virtual image 108. The concave reflective surface 210 has a curvature or other shape that, in conjunction with the correcting optical element 204, provides sufficient optical power for the virtual image 108 to virtually appear at any distance up to infinity away from the eye box 106.

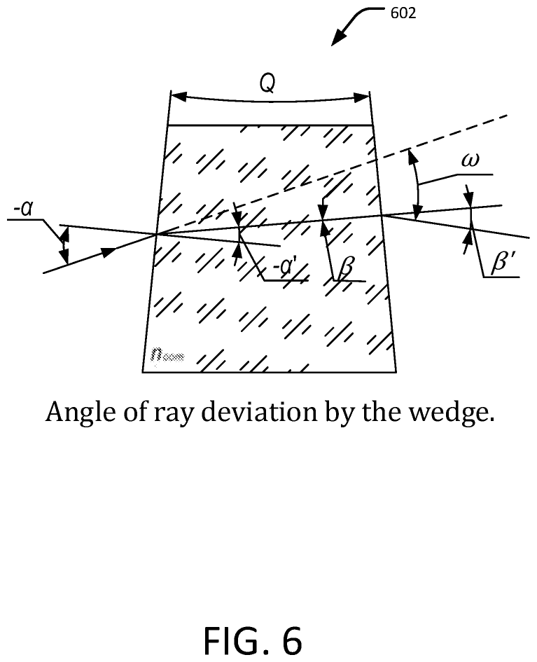

The convex transparent surface 212 includes (i) a second- or higher-order aspherical surface, (ii) a second- or higher-order decentered aspherical surface, or (iii) a freeform surface. The freeform surface of the convex transparent surface 212 can be a non-regular, three-dimensional geometric surface defined by a set of points or a set of parametric equations. The convex transparent surface 212 is configured to permit at least some external light 222 to pass through the combiner 202 and exit via the concave reflective surface 210. In this manner, the combiner 202 combines the external light 222 passing through the combiner 202 with the optical image 220 (as reflected off of the correcting optical element 204) to produce the output image 224, which is directed toward the eye box 106. In some examples, and as further detailed with respect to FIG. 6, the combiner 202 is configured such that an angle between imaginary and real observation directions through the combiner 202 from any eye position inside the pupil area of the eye box 106 does not exceed 1 milliradian. In this configuration, any optical distortions of the output image 224 caused by the curvature or shape of the concave reflective surface 210 are reduced or eliminated. In some examples, an anti-reflecting or beam-splitting coating can be applied to the convex transparent surface 212 to minimize flare or to otherwise control the effect of the external light 222 on the output image 224 for balancing the reflection and transparency of the combiner 202. In some examples, the convex transparent surface 212 has a radius of curvature of less than 350 mm.

In some examples, the optical system 200 includes the correcting optical element 204, which reduces the volume of the optical system 200 by permitting the PGU 206 to be located closer to the combiner 202 than would be possible without the correcting optical element 204 (such as if optical image 220 was projected directly onto the combiner 202). The correcting optical element 204 includes a convex reflective surface 214 configured to reflect the optical image 220 output from the PGU 206 toward the combiner 202. The convex reflective surface 214 includes (i) a second or higher order reflective aspherical surface, (ii) a second or higher order decentered aspherical surface, or (iii) a freeform surface. The freeform surface of the convex reflective surface 214 can be a non-regular, three-dimensional geometric surface defined by a set of points or a set of parametric equations. The convex reflective surface 214 has a shape such that a deviation, from a nominal value, of an angle between chief rays of the optical image 220 for each of left and right eyes at the eye box 106 does not exceed 2 milliradians while observing the virtual image 108 from the eye box 106, such as described in further detail with respect to FIG. 6. As used herein, the term “chief ray,” in addition to its plain and ordinary meaning, refers to a ray within of a cone-shaped region of light rays originating at a given point (for example, from a point on the convex reflective surface 210 of the combiner 202) and spreading outwardly and away from the point and toward an entrance pupil of an eye (for example, a pupil defined by the eye box 106). In some examples, the chief ray lies along an axis extending from the point to a mechanical or geographic center of the pupil. The value of the nominal angle in the horizontal plane between the chief rays for the left and right eyes depends on the distance from the observer to the virtual image 108. For example, the closer the virtual image 108 is to the eye box 106, the larger the nominal angle, and the farther the virtual image 108 is from the eye box 106, the smaller the nominal angle. Thus, virtual image distortions, caused by optical power of the reflective concave surface 210 of the combiner 202, are reduced by the shape of the convex reflective surface 214.

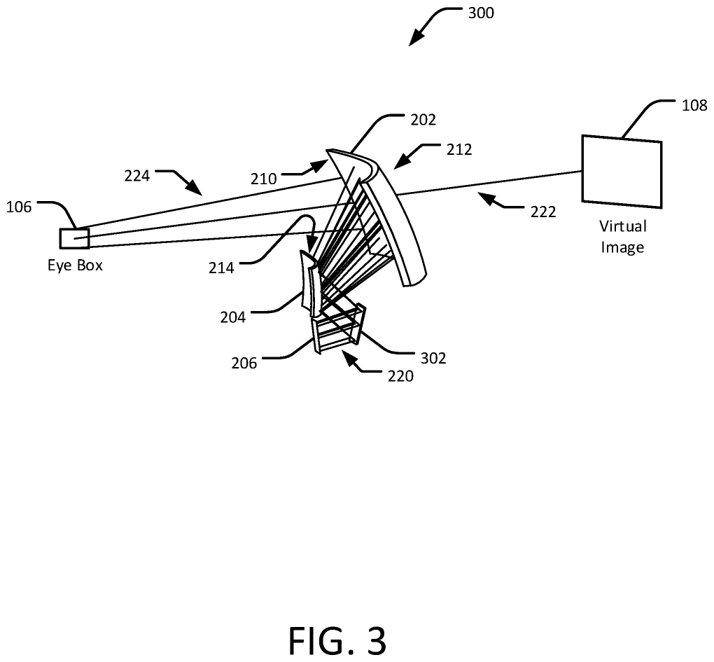

FIG. 3 is a schematic diagram of an optical system 300, in accordance with another example of the present disclosure. The optical system 300 can be implemented as at least a portion of the optical system 104 of FIG. 1. The optical system 300 is similar to the optical system 200 of FIG. 2, except that the optical system 300 further includes a secondary reflecting surface 302 configured to reflect the optical image 220 output from the PGU 206 toward the correcting optical element 204. In this configuration, the volume of the optical system 300 can be further reduced with respect to the volume of the optical system 200 by locating the PGU 206 closer to the correcting optical element 204. In some examples, the secondary reflecting surface 302 is a planar mirror. However, it will be appreciated that the secondary reflecting surface 302 can include a non-planar reflective surface that, in combination with the shapes of the a convex reflective surface 214 of the correcting optical element 204 and the reflective concave surface 210 of the combiner 202, provide the same or a substantially similar output image 224 as the optical system 200.

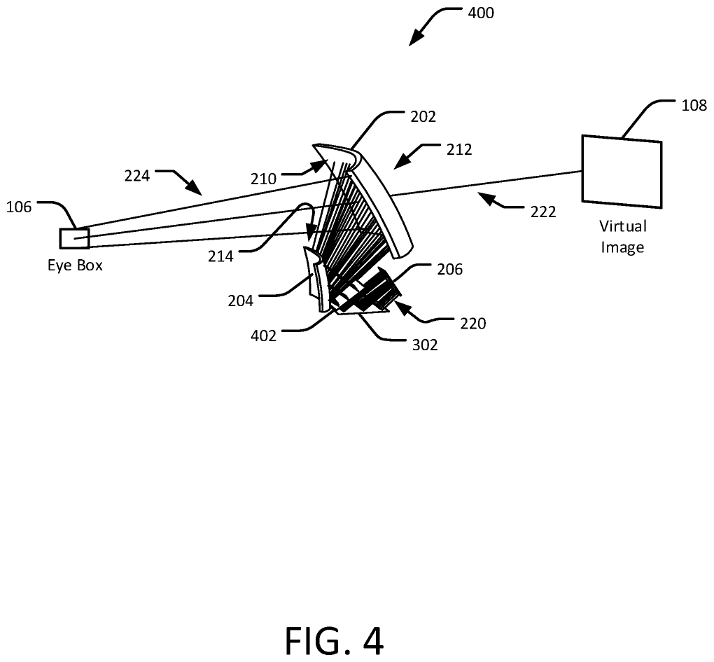

FIG. 4 is a schematic diagram of an optical system 400, in accordance with yet another example of the present disclosure. The optical system 400 can be implemented as at least a portion of the optical system 104 of FIG. 1. The optical system 400 is similar to the optical system 200 of FIG. 2 and the optical system 300 of FIG. 3, except that the optical system 400 further includes a light transmissive element 402 located between the secondary reflecting surface 302 and the correcting optical element 204. The light transmissive element 402 is configured to permit at least a portion of the optical image 220 to pass therethrough. In some examples, the light transmissive element 402 includes glass, a polycarbonate, or another suitable light-transmissive material, and can be configured to filter at least a portion of the light. As in the optical system 300, the secondary reflecting surface 302 is configured to reflect the optical image 220 output from the PGU 206 toward the correcting optical element 204 via the light transmissive element 402. In this configuration, the volume of the optical system 300 can be further reduced with respect to the volume of the optical system 200 by locating the PGU 206 closer to the combiner 202. In some examples, the secondary reflecting surface 302 is a planar mirror. However, it will be appreciated that the secondary reflecting surface 302 can include a non-planar reflective surface that, in combination with the shapes of the a convex reflective surface 214 of the correcting optical element 204 and the reflective concave surface 210 of the combiner 202, provide the same or a substantially similar output image 224 as the optical system 200.

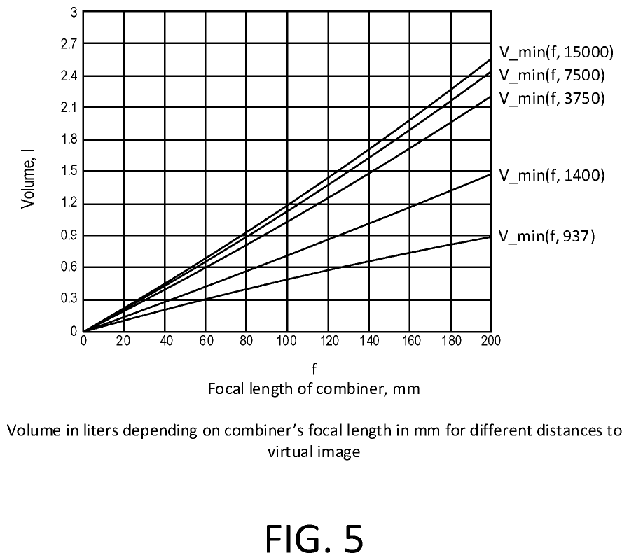

FIG. 5 is a graph showing the volume (size) of the optical system 200, 300, or 400 as a function of a focal length of the combiner 202 for different distances to the virtual image 108, in accordance with some examples. In some examples, the combiner 202 has a focal length of approximately 120 millimeters and the optical system 200 has a volume of approximately 1.4 liters. The graph depicts the estimated relations between the volume of the optical system 200, 300, 400 and the focal length of the combiner 202. For example, in this graph, the distance between the combiner 202 and the eye box 106 is 750 millimeters, the radius of a circular pupil zone within the eye box 106 is 45 millimeters, and the field of view (radius of observable image) is 4.5 degrees. The graph shows a significant increase in the volume of the optical system 200, 300, 400 when the virtual image 108 is at a distance of 1.5 meters or more from the eye box 106. Thus, in some examples, the concave reflective surface 210 has a radius of curvature of less than 350 mm, which permits the size of the optical system 200, 300, 400 to remain compact while providing sufficient optical power to locate the virtual image 108 at least 1.5 meters from the eye box 106. By contrast, systems with similar sizes (approximately 1.4 liters) but having combiners with insufficient optical power to locate the virtual image at least 1.5 meters from the eye box cause the distance from the observer to the virtual image to remain less than 1.5 meters and thus do not provide the ability to include augmented reality for greater distances.

FIG. 6 is a schematic diagram showing how a ray of light travels through an optical element, such as the combiner 202, in accordance with some examples. The combiner 202 can be represented as a combination of an infinite number of infinitely small elements. Each element is referred to as a wedge 602. In FIG. 6, co is the angle of ray deviation from a nominal value through the wedge 602, Q is the refractive angle of the wedge 602, n_{com} is the refractive index of the combiner's material, a is an angle of ray incidence onto the first surface, corresponding to the chosen direction of view, α′ is an angle of ray refraction onto the first surface, corresponding to the chosen direction of view, β is an angle of ray incidence onto the second surface, corresponding to the chosen direction of view, and β′ is angle of ray refraction onto the second surface, corresponding to the chosen direction of view.

A value of an angle between real and imaginary directions of a view through the wedge 602 at each possible eye position inside the pupil area (eye box) can be described by:

$$sin ( {α}^{′} ) = \frac{sin ( α )}{{n}_{c o m}} \qquad ( 1 )$$

As can be seen in FIG. 6:

β=Q+α′ (2)

It follows that:

sin(β′)=n_{com} sin(β)=n_{com} sin(Q+α′) (3)

The angle of ray deviation through the wedge 602 is:

ω=−α+α′+β′−β=β′−α−Q (4)

Because the refractive angle of the wedge 602 is low, equation (3) can be modified as follows:

β=Q cos(α′)+sin(α′) (5)

sin(β′)=sin(ω+Q+α)=(ω+Q)cos(α)+sin(α) (6)

Using equations (1), (5) and (6), the angle can be represented as:

$$ω = Q ( \frac{{n}_{c o m} cos ( {α}^{′} )}{cos ( α )} - 1 ) \qquad ( 7 )$$

$$ω = Q ( \frac{{n}_{c o m} cos ( arcsin ( \frac{sin ( α )}{{n}_{c o m}} ) )}{cos ( α )} - 1 ) \qquad ( 8 )$$

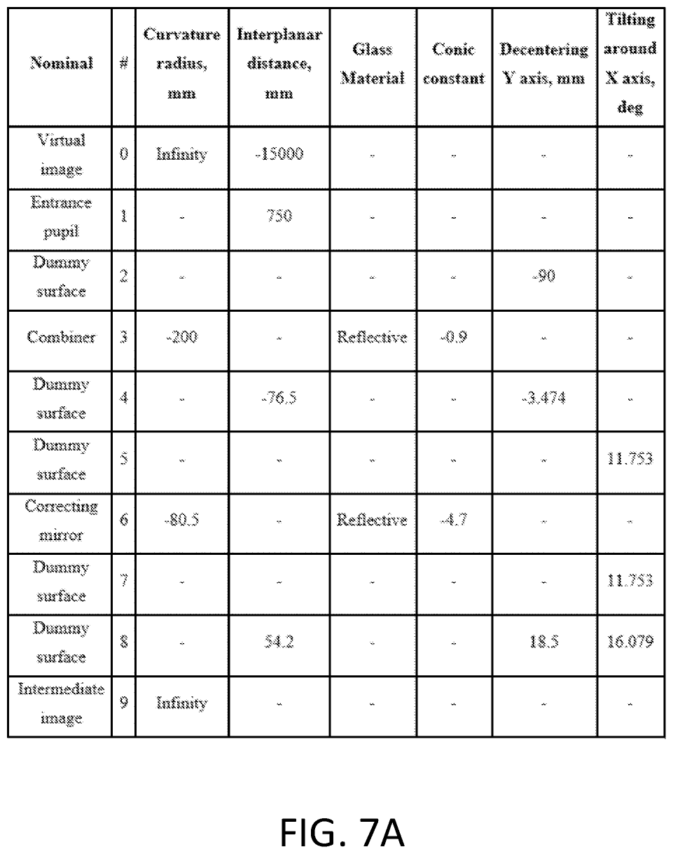

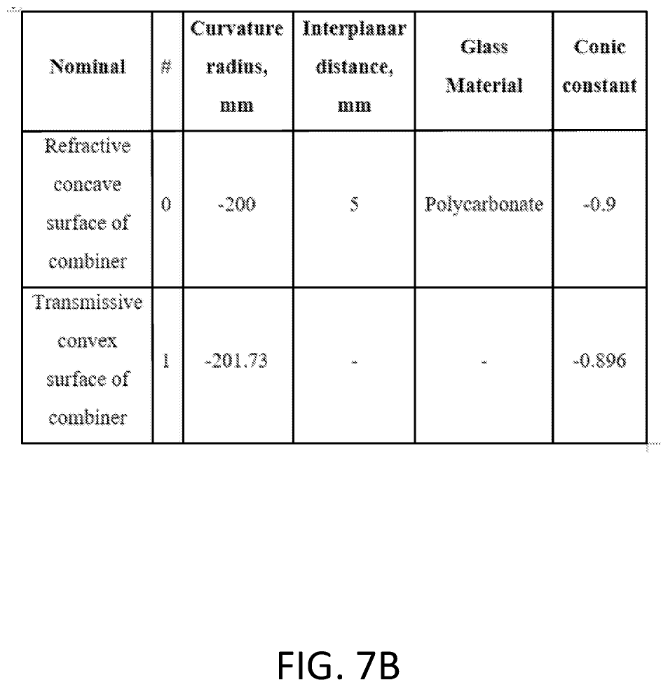

FIGS. 7A-B show a table listing various parameters of an optical system, in accordance with some examples. For example, the distance from the eye box 106 to the virtual image 108 is 15 meters, the distance from the eye box 106 to the combiner 202 is 750 mm, the pupil area (eye box) size is 88×22 millimeters (width by height), and the field of view is 8×4 degrees (width by height). The aspherical surfaces of the combiner 202 and the correcting optical element 204 can be described by a unified expression having different numbers of coefficients, such as listed in the table (e.g., the coefficients can define the curvature radius, the interplanar distance, the conic constant, the decentering axis, and/or the degree of tilt). For instance, a more sophisticated shape of the aspherical surfaces can be defined using more coefficients in the expression, thus increasing the optical correction potential of the surface.

Example Method

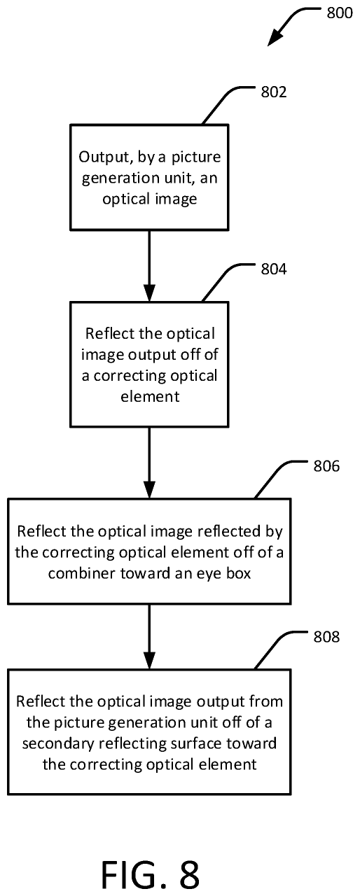

FIG. 8 is a flow diagram of a method 800 of combining external light with an optical image. The method 800 including outputting 802, by a picture generation unit, the optical image. The method 800 further includes reflecting 804 the optical image output off of a correcting optical element having a convex reflective surface. The convex reflective surface includes a second- or higher-order reflective aspherical surface, (ii) a second- or higher-order decentered aspherical surface, or (iii) a freeform surface. The method 800 further includes reflecting 806 the optical image reflected by the correcting optical element off of a combiner toward an eye box. The combiner has a concave reflective surface and a convex transparent surface. The concave reflective surface includes (i) a second- or higher-order aspherical surface, (ii) a second- or higher-order decentered aspherical surface, or (iii) a freeform surface. The convex transparent surface is configured to permit external light to pass through the combiner and combine with the optical image reflected by the correcting optical element. The convex transparent surface includes (i) a second- or higher-order aspherical surface, (ii) a second- or higher-order decentered aspherical surface, or (iii) a freeform surface.

In some examples, the convex transparent surface of the combiner is configured such that a value of an angle between imaginary and real observation directions through the combiner from any eye position inside the eye box does not exceed 1 milliradian. In some examples, the convex reflective surface of the correcting optical element is configured such that a deviation, from a nominal value, of an angle between chief rays of the optical image at the eye box does not exceed 2 milliradians. In some examples, the concave reflective surface of the combiner has a radius of curvature of less than 350 mm. In some examples, the method 800 includes reflecting 808 the optical image output from the picture generation unit off of a secondary reflecting surface toward the correcting optical element.

### Further Example Embodiments

The following examples describe further example embodiments, from which numerous permutations and configurations will be apparent.

Example 1 is an optical system including a picture generation unit configured to output an optical image; a correcting optical element having a convex reflective surface configured to reflect the optical image output by the picture generation unit, the convex reflective surface including a second- or higher-order reflective aspherical surface, (ii) a second- or higher-order decentered aspherical surface, or (iii) a freeform surface; and a combiner having a concave reflective surface and a convex transparent surface, the concave reflective surface configured to reflect the optical image reflected by the correcting optical element toward an eye box, the concave reflective surface including (i) a second- or higher-order aspherical surface, (ii) a second- or higher-order decentered aspherical surface, or (iii) a freeform surface, the convex transparent surface configured to permit external light to pass through the combiner and combine with the optical image reflected by the correcting optical element, the convex transparent surface including (i) a second- or higher-order aspherical surface, (ii) a second- or higher-order decentered aspherical surface, or (iii) a freeform surface.

Example 2 includes the subject matter of Example 1, wherein the convex transparent surface of the combiner is configured such that a value of an angle between imaginary and real observation directions through the combiner from any eye position inside the eye box does not exceed 1 milliradian.

Example 3 includes the subject matter of Examples 1 or 2, wherein the convex reflective surface of the correcting optical element is configured such that a deviation, from a nominal value, of an angle between chief rays of the optical image at the eye box does not exceed 2 milliradians.

Example 4 includes the subject matter of any one of Examples 1-3, wherein the concave reflective surface of the combiner has a radius of curvature of less than 350 mm.

Example 5 includes the subject matter of any one of Examples 1-4, wherein the picture generation unit includes a thin-film-transistor liquid-crystal display (TFT LCD), an organic light emitting diode (OLED), an Active Matrix Organic Light Emitting Diode (AMOLED), a digital micromirror device (DMD) projector, and/or a liquid crystal on silicon (LCOS) with a light emitting diode (LED), a laser projector.

Example 6 includes the subject matter of any one of Examples 1-5, including a secondary reflecting surface configured to reflect the optical image output from the picture generation unit toward the correcting optical element.

Example 7 includes the subject matter of Example 6, including a light transmissive element configured to permit at least a portion of the optical image to pass therethrough.

Example 8 is an optical system including a picture generation unit configured to output an optical image; a correcting optical element having a convex reflective surface configured to reflect the optical image output by the picture generation unit; and a combiner having a concave reflective surface and a convex transparent surface, the concave reflective surface configured to reflect the optical image reflected by the correcting optical element toward an eye box, the convex transparent surface configured to permit external light to pass through the combiner and combine with the optical image reflected by the correcting optical element, wherein the correcting optical element is configured such that a value of an angle between imaginary and real observation directions through the combiner from any eye position inside the eye box does not exceed 1 milliradian, and wherein the convex reflective surface of the correcting optical element is configured such that a deviation, from a nominal value, of an angle between chief rays of the optical image at the eye box does not exceed 2 milliradians.

Example 9 includes the subject matter of Example 8, wherein the convex reflective surface of the correcting optical element includes a second- or higher-order reflective aspherical surface, (ii) a second- or higher-order decentered aspherical surface, or (iii) a freeform surface.

Example 10 includes the subject matter of Examples 8 or 9, wherein the convex transparent surface of the combiner includes (i) a second- or higher-order aspherical surface, (ii) a second- or higher-order decentered aspherical surface, or (iii) a freeform surface.

Example 11 includes the subject matter of any one of Examples 8-10, wherein the concave reflective surface of the combiner includes (i) a second- or higher-order aspherical surface, (ii) a second- or higher-order decentered aspherical surface, or (iii) a freeform surface.

Example 12 includes the subject matter of any one of Examples 8-11, wherein the concave reflective surface of the combiner has a radius of curvature of less than 350 mm.

Example 13 includes the subject matter of any one of Examples 8-12, wherein the picture generation unit includes a thin-film-transistor liquid-crystal display (TFT LCD), an organic light emitting diode (OLED), an Active Matrix Organic Light Emitting Diode (AMOLED), a digital micromirror device (DMD) projector, and/or a liquid crystal on silicon (LCOS) with a light emitting diode (LED), a laser projector.

Example 14 includes the subject matter of any one of Examples 8-13, including a secondary reflecting surface configured to reflect the optical image output from the picture generation unit toward the correcting optical element.

Example 15 includes the subject matter of Example 14, including a light transmissive element configured to permit at least a portion of the optical image reflected off of the secondary reflecting surface to pass through toward the correcting optical element.

Example 16 is a method of combining external light with an optical image, the method including outputting, by a picture generation unit, the optical image; reflecting the optical image output off of a correcting optical element having a convex reflective surface, the convex reflective surface including a second- or higher-order reflective aspherical surface, (ii) a second- or higher-order decentered aspherical surface, or (iii) a freeform surface; and reflecting the optical image reflected by the correcting optical element off of a combiner toward an eye box, the combiner having a concave reflective surface and a convex transparent surface, the concave reflective surface including (i) a second- or higher-order aspherical surface, (ii) a second- or higher-order decentered aspherical surface, or (iii) a freeform surface, the convex transparent surface configured to permit external light to pass through the combiner and combine with the optical image reflected by the correcting optical element, the convex transparent surface including (i) a second- or higher-order aspherical surface, (ii) a second- or higher-order decentered aspherical surface, or (iii) a freeform surface.

Example 17 includes the subject matter of Example 16, wherein the convex transparent surface of the combiner is configured such that a value of an angle between imaginary and real observation directions through the combiner from any eye position inside the eye box does not exceed 1 milliradian.

Example 18 includes the subject matter of Examples 16 or 17, wherein the convex reflective surface of the correcting optical element is configured such that a deviation, from a nominal value, of an angle between chief rays of the optical image at the eye box does not exceed 2 milliradians.

Example 19 includes the subject matter of any one of Examples 16-18, wherein the concave reflective surface of the combiner has a radius of curvature of less than 350 mm.

Example 20 includes the subject matter of any one of Examples 16-19, further including causing the optical image output from the picture generation unit to reflect off of a secondary reflecting surface toward the correcting optical element.

The foregoing description and drawings of various embodiments are presented by way of example only. These examples are not intended to be exhaustive or to limit the present disclosure to the precise forms disclosed. Alterations, modifications, and variations will be apparent in light of this disclosure and are intended to be within the scope of the present disclosure as set forth in the claims. Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. An optical system comprising:
a picture generation unit configured to output an optical image;
a correcting optical element having a convex reflective surface configured to reflect the optical image output by the picture generation unit, the convex reflective surface including a second- or higher-order reflective aspherical surface, (ii) a second- or higher-order decentered aspherical surface, or (iii) a freeform surface; and
a combiner having a concave reflective surface and a convex transparent surface, the concave reflective surface configured to reflect the optical image reflected by the correcting optical element toward an eye box, the concave reflective surface including (i) a second- or higher-order aspherical surface, (ii) a second- or higher-order decentered aspherical surface, or (iii) a freeform surface, the convex transparent surface configured to permit external light to pass through the combiner and combine with the optical image reflected by the correcting optical element, the convex transparent surface including (i) a second- or higher-order aspherical surface, (ii) a second- or higher-order decentered aspherical surface, or (iii) a freeform surface.

2. The optical system of claim 1, wherein the convex transparent surface of the combiner is configured such that a value of an angle between imaginary and real observation directions through the combiner from any eye position inside the eye box does not exceed 1 milliradian.

3. The optical system of claim 1, wherein the convex reflective surface of the correcting optical element is configured such that a deviation, from a nominal value, of an angle between chief rays for a left eye and a right eye within the eye box does not exceed 2 milliradians.

4. The optical system of claim 1, wherein the concave reflective surface of the combiner has a radius of curvature of less than 350 mm.

5. The optical system of claim 1, wherein the picture generation unit includes a thin-film-transistor liquid-crystal display (TFT LCD), an organic light emitting diode (OLED), an Active Matrix Organic Light Emitting Diode (AMOLED), a digital micromirror device (DMD) projector, and/or a liquid crystal on silicon (LCOS) with a light emitting diode (LED), a laser projector.

6. The optical system of claim 1, comprising a secondary reflecting surface configured to reflect the optical image output from the picture generation unit toward the correcting optical element.

7. The optical system of claim 6, comprising a light transmissive element configured to permit at least a portion of the optical image to pass therethrough.

8. An optical system comprising:
a picture generation unit configured to output an optical image;
a correcting optical element having a convex reflective surface configured to reflect the optical image output by the picture generation unit; and
a combiner having a concave reflective surface and a convex transparent surface, the concave reflective surface configured to reflect the optical image reflected by the correcting optical element toward an eye box, the convex transparent surface configured to permit external light to pass through the combiner and combine with the optical image reflected by the correcting optical element,
wherein the correcting optical element is configured such that a value of an angle between imaginary and real observation directions through the combiner from any eye position inside the eye box does not exceed 1 milliradian, and
wherein the convex reflective surface of the correcting optical element is configured such that a deviation, from a nominal value, of an angle between chief rays for a left eye and a right eye within the eye box does not exceed 2 milliradians.

9. The optical system of claim 8, wherein the convex reflective surface of the correcting optical element includes a second- or higher-order reflective aspherical surface, (ii) a second- or higher-order decentered aspherical surface, or (iii) a freeform surface.

10. The optical system of claim 8, wherein the convex transparent surface of the combiner includes (i) a second- or higher-order aspherical surface, (ii) a second- or higher-order decentered aspherical surface, or (iii) a freeform surface.

11. The optical system of claim 8, wherein the concave reflective surface of the combiner includes (i) a second- or higher-order aspherical surface, (ii) a second- or higher-order decentered aspherical surface, or (iii) a freeform surface.

12. The optical system of claim 8, wherein the concave reflective surface of the combiner has a radius of curvature of less than 350 mm.

13. The optical system of claim 8, wherein the picture generation unit includes a thin-film-transistor liquid-crystal display (TFT LCD), an organic light emitting diode (OLED), an Active Matrix Organic Light Emitting Diode (AMOLED), a digital micromirror device (DMD) projector, and/or a liquid crystal on silicon (LCOS) with a light emitting diode (LED), a laser projector.

14. The optical system of claim 8, comprising a secondary reflecting surface configured to reflect the optical image output from the picture generation unit toward the correcting optical element.

15. The optical system of claim 14, comprising a light transmissive element configured to permit at least a portion of the optical image reflected off of the secondary reflecting surface to pass through toward the correcting optical element.

16. A method of combining external light with an optical image, the method comprising:
outputting, by a picture generation unit, the optical image;
reflecting the optical image output off of a correcting optical element having a convex reflective surface, the convex reflective surface including a second- or higher-order reflective aspherical surface, (ii) a second- or higher-order decentered aspherical surface, or (iii) a freeform surface; and
reflecting the optical image reflected by the correcting optical element off of a combiner toward an eye box, the combiner having a concave reflective surface and a convex transparent surface, the concave reflective surface including (i) a second- or higher-order aspherical surface, (ii) a second- or higher-order decentered aspherical surface, or (iii) a freeform surface, the convex transparent surface configured to permit external light to pass through the combiner and combine with the optical image reflected by the correcting optical element, the convex transparent surface including (i) a second- or higher-order aspherical surface, (ii) a second- or higher-order decentered aspherical surface, or (iii) a freeform surface.

17. The method of claim 16, wherein the convex transparent surface of the combiner is configured such that a value of an angle between imaginary and real observation directions through the combiner from any eye position inside the eye box does not exceed 1 milliradian.

18. The method of claim 16, wherein the convex reflective surface of the correcting optical element is configured such that a deviation, from a nominal value, of an angle between chief rays for a left eye and a right eye within the eye box does not exceed 2 milliradians.

19. The method of claim 16, wherein the concave reflective surface of the combiner has a radius of curvature of less than 350 mm.

20. The method of claim 16, further comprising reflecting the optical image output from the picture generation unit off of a secondary reflecting surface toward the correcting optical element.
